(19) United States
(12) Patent Application Publication
(10) Pub. No.: US 2016/0348193 A1
(43) Pub. Date: Dec. 1, 2016

(54) LIGNOCELLULOSE BIOMASS TREATMENT DEVICE, TREATMENT METHOD, TREATED PRODUCT, AND SACCHARIFICATION METHOD

(71) Applicants: Kato Biomass Technology Co., Ltd., Sapporo-shi, Hokkaido (JP); Susumu, Sapporo-shi, Hokkaido (JP)

(72) Inventor: Susumu Kato, Hokkaido (JP)

(21) Appl. No.: 15/107,168

(22) PCT Filed: Dec. 24, 2014
(86) PCT No.: PCT/JP14/84116

§ 371 Date: Jun. 22, 2016

(30) Foreign Application Priority Data
Dec. 25, 2013 (JP) 2013-267588

(51) Int. Cl. C13K 1/02; B02C 19/22

(52) U.S. Cl. CPC C13K 1/02; B02C 19/22

(57) ABSTRACT

A lignocellulosic biomass treatment device (100) includes at least one screw (110) that has spiral screw grooves (110a, 110b) formed in an outer periphery of the screw, a barrel (120) that has a spiral barrel groove (120a) formed in an inner periphery of the barrel, and surrounding a portion of the screw (110) where the screw grooves (110a, 110b) are formed, and a chute (130) to put lignocellulosic biomass into a gap (135) between the screw (110) and the barrel (120). By a rotation of the screw (110), the lignocellulosic biomass is milled while a pressure is applied thereto in the gap (135).

### TECHNICAL FIELD

The present disclosure relates to a lignocellulosic biomass treatment device, a lignocellulosic biomass treatment method, a treated lignocellulosic biomass product, and a lignocellulosic biomass saccharification method.

### BACKGROUND ART

Global warming has become a concern in recent years, and production of bioethanol using lignocellulosic biomass materials has been getting attention in order to reduce the carbon dioxide emission amount.

Lignocellulosic biomass is generally classified into an herbaceous type and a woody type, and has characteristics of containing lignocellulose that has cellulose strongly bonded to lignin and hemicellulose.

When bioethanol is produced from lignocellulosic biomass, polysaccharides in the lignocellulosic biomass need to be hydrolyzed (saccharified) by enzyme and strong acid, and be decomposed into monosaccharides. However, in lignocellulose, cellulose fibers are formed by regular aggregations of cellulose molecules in cell walls, and thus the lignocellulose exhibits very strong decomposition resistance against biochemical or chemical treatments, such as enzyme and acid. Thus, there is a problem of decreasing the saccharification efficiency of the lignocellulosic biomass.

Accordingly, studies on pre-treatment methods to improve the saccharification efficiency of the lignocellulosic biomass have been conducted, and several reports have been made on such studies.

Patent Literature 1 discloses a treatment method including a step of treating lignocellulosic biomass materials with pressurized hot water, and a step of performing a mechanical milling treatment on the hot-water-treated materials.

In addition, Patent Literature 2 discloses a method for mixing a cellulosic substance with a defibration substance like water, and performing a mechanical milling using a ball mill or the like.

Still further, Patent Literature 3 discloses a pre-treatment step to perform hydrolysis on cellulose as a material to obtain saccharides. According to this pre-treatment step, a cellulose slurry having undergone coarse milling treatment and having been introduced into a pre-treatment container is wet milled under a high temperature and high pressure condition in which a temperature is between 140 and 220° C., and a pressure at this temperature is equal to or greater than a saturation pressure of the slurry.

Yet still further, Patent Literature 4 discloses a hydrothermal decomposition device that delivers biomass materials to an internal section of an inclined-type device main body from a lower end thereof by a delivery screw, supplies pressurized hot water to the internal section of the device main body from an upper end side that differs from the biomass material supply location, performs a hydrothermal decomposition with the biomass materials and the pressurized hot water facing each other and being in contact with each other, and isolates the lignin components and hemicellulose components in the pressurized hot water.

Moreover, Patent Literature 5 discloses a method including an ozone treatment step of making lignocellulose more brittle under the ozone atmosphere, and a milling step of mechanically milling the lignocellulose by, for example, a ball mill.

### CITATION LIST

### Patent Literature

Patent Literature 1: Unexamined Japanese Patent Application Kokai Publication No. 2006-136263

Patent Literature 2: Unexamined Japanese Patent Application Kokai Publication No. 2008-274247

Patent Literature 3: Unexamined Japanese Patent Application Kokai Publication No. 2009-284867

Patent Literature 4: Unexamined Japanese Patent Application Kokai Publication No. 2010-029862

Patent Literature 5: Unexamined Japanese Patent Application Kokai Publication No. 2012-193353

### SUMMARY OF INVENTION

### Technical Problem

However, the methods disclosed in Patent Literature 1 and Patent Literature 2 require a total treatment time of several hours to several tens of hours, and a problem remains with the lengthy treatment time. As for the method disclosed in Patent Literature 3, large-scale facilities are needed because a pressurizing pump is applied. As for the device disclosed in Patent Literature 4, facilities also become large scale because the structure includes a biomass supply device, the device main body, and a biomass extraction device. As for the method disclosed in Patent Literature 5, there are difficulties, such as a lengthy treatment time, and complexity of treatment steps, because the method includes the ozone treatment step.

The present disclosure has been made in view of the aforementioned circumstances, and an objective of the present disclosure is to provide a lignocellulosic biomass treatment device, a lignocellulosic biomass treatment method, a treated lignocellulosic biomass product, and a lignocellulosic biomass saccharification method, which are capable of treating the lignocellulosic biomass in a short time, and at low costs.

### Solution to Problem

To achieve the objectives above, there is provided in accordance with a first aspect of the present disclosure, a lignocellulosic biomass treatment device including:

at least one screw that has a screw groove in a spiral shape formed in an outer periphery of the screw;

a barrel that has a barrel groove in a spiral shape formed in an inner periphery of the barrel, and surrounding a portion of the screw where the screw groove is formed; and

a chute to put a lignocellulosic biomass into a gap between the screw and the barrel,

wherein by a rotation of the screw, the lignocellulosic biomass is milled while a pressure is applied thereto in the gap.

For example, the lignocellulosic biomass treatment device further includes a heater provided in a vicinity of a front end of the barrel, and heats the milled lignocellulosic biomass.

For example, the lignocellulosic biomass treatment device further includes a compressor that has a discharge opening in the front end of the barrel.

For example, a depth of the screw groove becomes shallower toward a front side.

For example, a width of the barrel groove becomes narrower toward the front side.

For example, the screw groove includes a bottom surface, two side surfaces that stand upwardly from the bottom surface at a predetermined angle, and a side surface that stands upwardly from at least one of the two side surfaces at a predetermined angle.

For example, a groove pitch at a front end side in the screw groove is smaller than a groove pitch at a back end side.

For example, a number of the screws is two.

In accordance with a second aspect of the present disclosure, there is provided a lignocellulosic biomass treatment method including:

a milling step of milling, by a rotation of a screw, a lignocellulosic biomass while applying pressure thereto in a gap between at least the one screw that includes a screw groove in a spiral shape formed in an outer periphery of the screw, and a barrel that includes a barrel groove in a spiral shape formed in an inner periphery thereof, and surrounding a portion of the screw where the screw groove is formed; and

a heating step of heating the milled lignocellulosic biomass by a heater provided in a vicinity of a front end of the barrel.

For example, the lignocellulosic biomass treatment method further includes a step of puffing the milled lignocellulosic biomass after the heating step.

In accordance with a third aspect of the present disclosure, there is provided a treated lignocellulosic biomass product that is obtained by the treatment method according to the second aspect of the present disclosure.

In accordance with a fourth aspect of the present disclosure, there is provided a lignocellulosic biomass saccharification method including a step of saccharifying the treated lignocellulosic biomass product according to the third aspect of the present disclosure.

### Advantageous Effects of Invention

According to the present disclosure, the lignocellulosic biomass treatment device, the lignocellulosic biomass treatment method, the treated lignocellulosic biomass product, and the lignocellulosic biomass saccharification method, capable of treating the lignocellulosic biomass in a short time and at low costs can be provided.

### BRIEF DESCRIPTION OF DRAWINGS

FIG. 1 is an exemplary side view that illustrates an internal structure of a lignocellulosic biomass treatment device according to an embodiment of the present disclosure.

FIG. 2 is a partial side view of a screw that shows a closer look at screw grooves formed in an outer periphery of the screw.

FIG. 3 is an exemplary side view that illustrates an internal structure of a lignocellulosic biomass treatment device according to another embodiment of the present disclosure.

FIG. 4 is an exemplary side view that illustrates an internal structure of a lignocellulosic biomass treatment device according to the other embodiment of the present disclosure.

### DESCRIPTION OF EMBODIMENTS

Hereinafter, embodiments of the present disclosure will be described in detail.

First, a lignocellulosic biomass treatment device 100 according to an embodiment of the present disclosure will be explained.

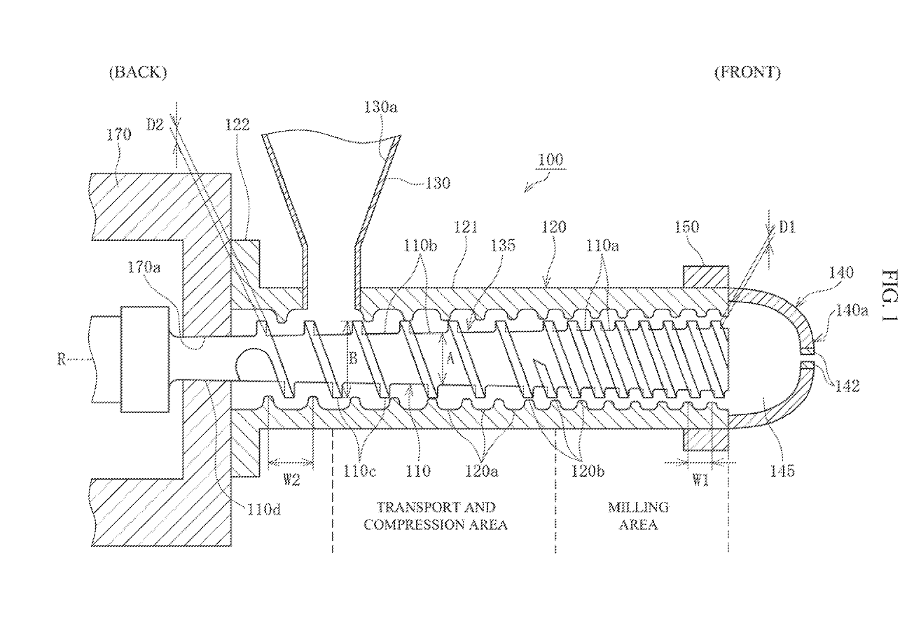

FIG. 1 is an exemplary partial cross sectional view that illustrates an entire structure and an internal structure of the lignocellulosic biomass treatment device 100 according to the embodiment of the present disclosure. The explanation will be given below of the structure of the lignocellulosic biomass treatment device 100 with reference to this figure.

Note that in the present specification, a front and back orientation of the lignocellulosic biomass treatment device 100 is as illustrated in FIG. 1, and the right side in the figure is the front side, and the left side in the figure is the back side.

The lignocellulosic biomass treatment device 100 according to this embodiment of the present disclosure is a device to treat lignocellulosic biomass. This device efficiently mills the lignocellulosic biomass, and thus the device can release an entanglement of lignin, and expose polysaccharide components. Hence, the saccharification efficiency can be significantly improved when a treated lignocellulosic biomass product obtained by the device is used in saccharification reaction.

In the present specification, “lignocellulosic biomass” means a stalk, a leaf, a root, a trunk, a panicle, a flower, a fruit, and the like of a plant body which are tissues and organs originating from plants. In addition, the lignocellulosic biomass is generally classified into an herbaceous type and a woody type. Example herbaceous lignocellulosic biomass applicable are, corn (corn dust, broken corn, corn stover, and the like), rice, wheat, barley, oats, sugarcane, sorghum, Erianthus, Miscanthus, Napier grass, silver grass, and switchgrass. In addition, pasture grass, monocot weeds, a stalk and a leaf of a dicot plant, and the like are also applicable. Example woody lignocellulosic biomass applicable are a trunk, a branch, a leaf, and a fruit of conifers, those of broadleaf trees, and those of a gymnosperm. Any lignocellulosic biomass that accomplishes the effects of the present disclosure is applicable as needed. The aforementioned lignocellulosic biomass is chopped to a length and a width equal to or less than 20 mm, respectively to be utilized.

As illustrated in FIG. 1, a lignocellulosic biomass treatment device 100 according to this embodiment of the present disclosure includes a screw 110, a barrel 120, a chute 130, a compressor 140, a heater 150, and a bearing 170. Note that FIG. 1 illustrates the components other than the screw 110 in a condition in which these components are cut along a plane parallel to the figure to facilitate understanding of an internal structure of the lignocellulosic biomass treatment device 100.

The screw 110 has a substantially columnar shape, and is driven by a driving device (unillustrated) attached to a back end of the screw so as to rotate around a rotation shaft R. When the lignocellulosic biomass treatment device 100 is viewed from the back side, the screw 110 is driven by the driving device (unillustrated) so as to rotate in the counterclockwise direction. The lignocellulosic biomass treatment device 100 according to this embodiment of the present disclosure includes a single screw 110.

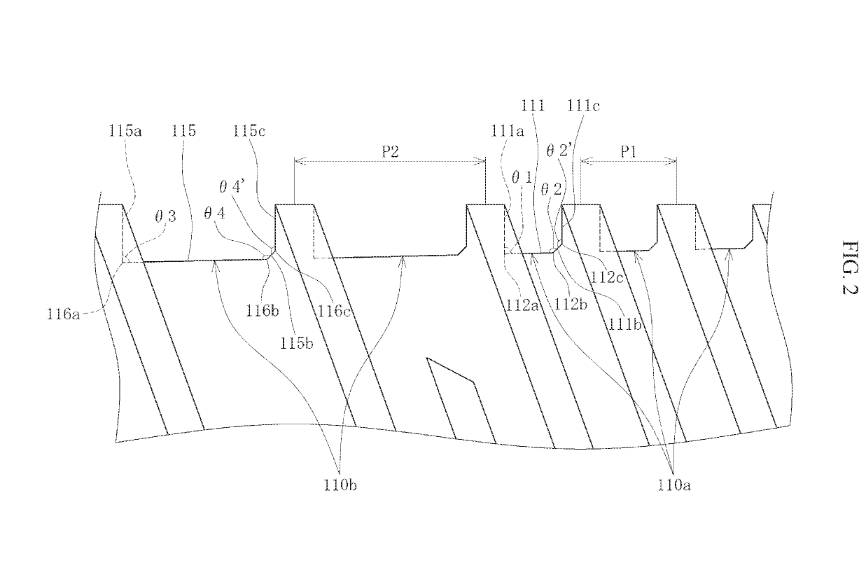

Formed in an outer periphery of the screw 110 in a spiral shape are a first screw groove 110a at the front end side, and a second screw groove 110b at the back end side, each having a pitch that differs from each other. The first screw groove 110a is a spiral groove with a pitch P1 (a groove pitch at the front end side) (FIG. 2) provided within a predetermined range from the front end of the screw 110. The second screw groove 110b is a spiral groove with a greater pitch P2 (a groove pitch at the back end side) (FIG. 2) than the pitch P1 of the first screw groove 110a, and is provided within a predetermined range at the back side relative to the first screw groove 110a. Note that as illustrated in FIG. 1, in the present specification, an area of the screw 110 where the second screw groove 110b is provided is sometimes referred to as a “transport and compression area” of the lignocellulosic biomass treatment device 100, and an area of the screw 110 where the first screw groove 110a is provided is sometimes referred to as a “milling area” of the lignocellulosic biomass treatment device 100.

As illustrated in FIG. 2, the first screw groove 110a is formed with a first bottom surface 111, a first side surface 111a standing upwardly from one side of the first bottom surface 111, a second side surface 111b standing upwardly from another side of the first bottom surface 111, and a third side surface 111c standing upwardly from an opposite side to that of the first bottom surface 111 of the second side surface 111b. The first side surface 111a stands upwardly from the first bottom surface 111 at an intersection angle θ1, and a first edge 112a with no roundness is formed at the intersecting location. The second side surface 111b stands upwardly from the first bottom surface 111 at an intersection angle θ2, and a second edge 112b with no roundness is formed at the intersecting location. The third side surface 111c stands upwardly from the second side surface 111b at an intersection angle θ2′, and a third edge 112c with no roundness is formed at the intersecting location. The intersection angle θ1 is smaller than the intersection angles θ2 and θ2′.

As illustrated in FIG. 2, the second screw groove 110b is formed with a second bottom surface 115, a fourth side surface 115a standing upwardly from one side of the second bottom surface 115, a fifth side surface 115b standing upwardly from another side of the second bottom surface 115, and a sixth side surface 115c standing upwardly from an opposite side to that of the second bottom surface 115 of the fifth side surface 115b. The fourth side surface 115a stands upwardly from the second bottom surface 115 at an intersection angle θ3, and a fourth edge 116a with no roundness is formed at the intersecting location. The fifth side surface 115b stands upwardly from the second bottom surface 115 at an intersection angle θ4, and a fifth edge 116b with no roundness is formed at the intersecting location. The sixth side surface 115c stands upwardly from the fifth side surface 115b at an intersection angle θ4′, and a sixth edge 116c with no roundness is formed at the intersecting location. The intersection angle θ3 is smaller than the intersection angles θ4 and θ4′.

Accordingly, the first screw groove 110a, and the second screw groove 110b that are not flat-cut-type grooves, but have respective edges with no roundness, are formed in the screw 110. By having these edges with no roundness, the lignocellulosic biomass can be efficiently milled, thereby releasing the entanglement of lignin in the lignocellulosic biomass, and exposing polysaccharide components.

The rotation of the screw 110 driven by the aforementioned driving device (unillustrated) together with the barrel 120 causes the lignocellulosic biomass to be milled while pressure is applied thereto as will be discussed later herein. Note that, as described above, a smaller pitch P1 (FIG. 2) of the first screw groove 110a than the pitch P2 (FIG. 2) of the second screw groove 110b is formed. Thus, the depressing force applied to the lignocellulosic biomass can be progressively increased toward the front side of the screw 110, thereby efficiently milling the cellulosic biomass.

In addition, as illustrated in FIG. 1, a depth of the first screw groove 110a, and that of the second screw groove 110b become shallower toward the front side. A ratio between a groove depth D1 of the first screw groove 110a at the forefront end and a groove depth D2 of the second screw groove 110b at the backmost end is 70:100 (D1:D2=70:100) (FIG. 1). Thus, by employing the depth of the first screw groove 110a, and that of the second screw groove 110b that respectively become shallower toward the front side, the depressing force applied to the lignocellulosic biomass can be progressively increased toward the front side of the screw 110. Consequently, the lignocellulosic biomass can be efficiently milled.

Note that, as illustrated in FIG. 1, a diameter A of a valley in the screw 110 becomes greater toward the front side, and an outer diameter B of the screw 110 is uniform from the back end to the front end.

As illustrated in FIG. 1, the barrel 120 includes a cylindrical member 121 in a substantially cylindrical shape, and a flange 122 that is provided at an end of the cylindrical member 121, and is fastened to the bearing 170. The fastening of the barrel 120 (the flange 122) to the bearing 170 can be achieved by a conventionally well-known method, such as bolting or welding. The barrel 120 receives a part of the screw 110 in an internal space that causes the cylindrical member 121 and the flange 122 to be in communication with each other. Thus, the part of the screw 110 in which the first screw groove 110a, and the second screw groove 110b are formed is surrounded by the barrel 120.

As illustrated in FIG. 1, a spiral barrel groove 120a is formed in an inner periphery of the barrel 120. The barrel groove 120a together with the screw 110 serves to mill the lignocellulosic biomass. By having the barrel groove 120a, friction force between the lignocellulosic biomass and the inner periphery of the barrel 120 increases, and thus the lignocellulosic biomass can be efficiently milled. The barrel groove 120a is formed in a corrugated shape that has each edge rounded (FIG. 1). By having the barrel groove 120a formed in such a shape, the lignocellulosic biomass can smoothly move forward without being stuck in the comers of the barrel groove 120a. In addition, a width of the barrel groove 120a becomes narrower toward the front side. A ratio between a width W1 of the barrel groove 120a at the forefront end and a width W2 of the barrel groove 120a at the backmost end is 20:100 (W1:W2=20:100) (FIG. 1). Accordingly, since the width of the barrel groove 120a becomes narrower toward the front side, the depressing force applied to the lignocellulosic biomass can be progressively increased toward the front end direction of the screw 110, thereby efficiently milling the cellulosic biomass.

The bearing 170 holds the flange 122 of the barrel 120, and rotatably supports the screw 110. The bearing 170 has a bearing surface 170a, and receives force from a journal 110d of the screw 110 that passes completely through the bearing. Accordingly, the screw 110 is rotatably supported by the bearing 170, and thus without any off-centering, the screw 110 is capable of rotating stably.

Note that a total length (a length in the back and front direction) of the screw 110, and that of the barrel 120 are adjusted as needed in accordance with the hardness of the lignocellulosic biomass. That is, when a hard material (lignocellulosic biomass) is applied, the total length of the screw 110, and that of the barrel 120 are made longer in order to sufficiently mill the hard material. In addition, when the length and width of the material are large, and when a woody material is applied, the screw 110 and the barrel 120 are designed so as to have sufficiently long total lengths of the “milling area” toward the front side in order to surely mill the material.

The chute 130 is to put the lignocellulosic biomass into a gap 135 between the screw 110 and the barrel 120. The chute 130 includes a chute inlet 130a which passes completely through the cylindrical member 121 of the barrel 120 from an exterior surface, and is in communication with an internal section of the barrel 120. Note that a location to which the chute 130 is attached is the back side of the barrel 120. The lignocellulosic biomass that is put into the gap 135 through the chute 130 is milled in the gap 135 by the rotating screw 110. More specifically, first, the lignocellulosic biomass that has put in enters the second screw groove 110b of the screw 110, and the barrel groove 120a of the barrel 120. In addition, the entered lignocellulosic biomass is transported by the rotating screw 110, and gradually compressed in the “transport and compression area” (FIG. 1) of the lignocellulosic biomass treatment device 100. Subsequently, in the “milling area” (FIG. 1) of the lignocellulosic biomass treatment device 100, shifting of a peak 110c formed on the screw 110 by the rotating screw 110 causes the lignocellulosic biomass that has been entered into the barrel groove 120a of the barrel 120 to be crushed and grinded by the peak 110c. In addition, the lignocellulosic biomass entered into the first screw groove 110a is shifted in accordance with the shifting of the peak 110c, and thus the lignocellulosic biomass is crushed and grinded by a peak 120b formed on the barrel 120. Therefore, by having the peak 110c that is shifted in accordance with the rotation of the screw 110, the lignocellulosic biomass that has been milled in the gap 135 as explained above is gradually fed to an internal section (to be discussed later) of the compressor 140 through the “transport and compression area”, and the “milling area.”

As illustrated in FIG. 1, the heater 150 is disposed so as to surround a vicinity of the front end of the barrel 120. The heater 150 produces heat by electric power, and heats up the lignocellulosic biomass milled in the gap 135 to 110-180° C. By heating the lignocellulosic biomass to 110-180° C., the entanglement of the lignin is released, and the polysaccharide components can be easily exposed. The acceleration of the release of lignin entanglements may be achieved by heating because water contained in the lignocellulosic biomass is heated, and the lignocellulosic biomass is milled while being pressurized under a sort of steam-baking condition.

As illustrated in FIG. 1, the compressor 140 is provided at the forefront end of the barrel 120. The lignocellulosic biomass that has been milled by the rotating screw 110 is gradually fed to a compressor internal section 145 (a substantially closed space) that is an internal space of the compressor 140. In the compressor internal section 145, the lignocellulosic biomass fed by the rotating screw 110 is accumulated, pushed and pressurized under a substantially sealed condition. Most of the lignocellulosic biomass that has been fed to the compressor 140 is in a condition in which the entanglements of lignin are released, and polysaccharide components are exposed.

As illustrated in FIG. 1, a discharge opening 142 for discharging the lignocellulosic biomass that has been fed to the compressor internal section 145 is provided in a front surface 140a of the compressor 140. The shape of the discharge opening 142 as viewed from the front side of the lignocellulosic biomass treatment device 100 is substantially circular. In addition, the discharge opening is attached to a substantial center of the front surface 140a of the compressor 140 so as to be in communication with the compressor internal section 145. The lignocellulosic biomass that has been pushed and pressurized under the substantially sealed condition in the compressor internal section 145 is puffed by being ejected from the discharge opening 142. The puffing step accelerates the release of lignin entanglements in the lignocellulosic biomass. A suitable diameter of the discharge opening 142 is selected in consideration of the type of lignocellulosic biomass to be put.

As described above, the utilization of the lignocellulosic biomass treatment device 100 according to the embodiment of the present disclosure enables a successive milling of the lignocellulosic biomass by the rotating screw 110, and thus the entanglements of lignin in the cellulosic biomass can be released, and polysaccharide components can be exposed in a short time (for example, substantially five to 30 seconds depending on rotational speed), and in an efficient manner. The saccharification efficiency can be significantly improved because a treated product obtained by the device contains exposed polysaccharide components.

In addition, according to the lignocellulosic biomass treatment device 100 of this embodiment of the present disclosure, no chemicals are applied, and no large-scale facilities are needed, and thus the lignocellulosic biomass can be treated at low costs.

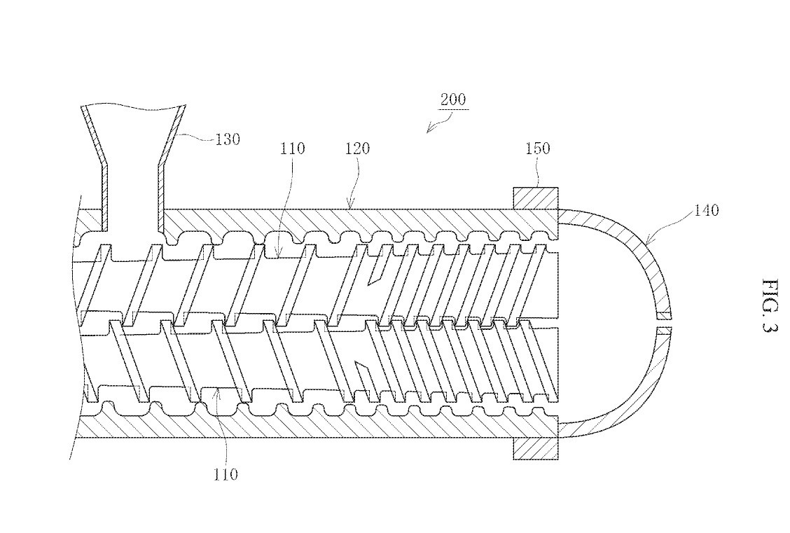

Note that the present disclosure is not limited to the aforementioned embodiment, and various modifications and applications can be made thereto. For example, in this embodiment, as illustrated in FIG. 1, the explanation was given of the case in which the single screw 110 is employed. However, as illustrated in FIG. 3, two screws 110 may be employed. In such a case, the two screws 110 are disposed adjacent to each other, and when a lignocellulosic biomass treatment device 200 is viewed from the back side, one screw 110 is rotated in the counterclockwise direction, while the other screw 110 is rotated in the clockwise direction by the driving device (unillustrated). In addition, the barrel 120 is formed in a substantially oval shape so as to surround the two screws 110. Note that details on the screw grooves 110a, 110b in the screws 110, details on the barrel groove 120a in the barrel 120, details on the chute 130, the compressor 140, the heater 150, and the like of the lignocellulosic biomass treatment device 200 (FIG. 3) are the same as those of the aforementioned lignocellulosic biomass treatment device 100. By employing such a two-shaft structure, a large amount of lignocellulosic biomass can be treated in a short time. In addition, the lignocellulosic biomass can be more efficiently treated because the lignocellulosic biomass can be pushed forward of the device more forcefully while being milled.

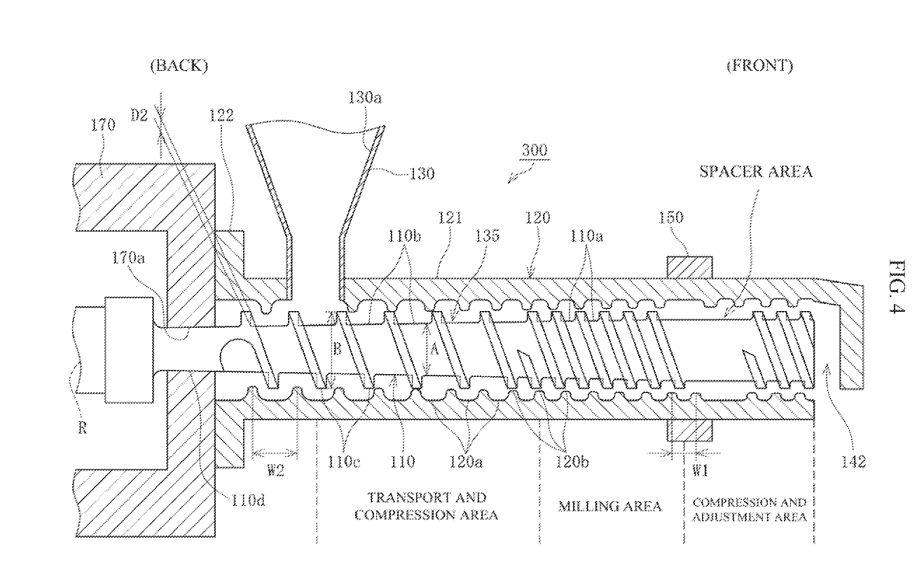

Still further, in this embodiment, as illustrated in FIG. 1, the explanation was given of the case in which the compressor 140 is provided. However, as illustrated in FIG. 4, a “spacer area” with no groove may be provided at the front side portion of the screw 110 that is also a location in the vicinity of the heater 150 so as to allow the lignocellulosic biomass to be directly ejected from the gap 135 via the discharge opening 142. In this case, the front side portion in the vicinity of the “spacer area” serves as a “compression and adjustment area” of a lignocellulosic biomass treatment device 300. In the “compression and adjustment area”, the lignocellulosic biomass that has been passed through the “transport and compression area”, and the “milling area” is compressed by the rotating screw 110.

Yet still further, in this embodiment, as illustrated in FIG. 1, the explanation was given of the case in which the diameter A of the valley in the screw 110 becomes greater toward the front side, and the outer diameter B of the screw 110 is uniform from the back end to the front end. However, the diameter A of the valley in the screw 110 may be uniform from the back end to the front end, or may become smaller toward the front side. In this case, the outer diameter B of the screw 110 becomes smaller toward the front side.

Moreover, in this embodiment, as illustrated in FIG. 1, the explanation was given of the case in which the heater 150 is provided in the vicinity of the front end of the barrel 120. However, the heater 150 may be disposed so as to stride over the barrel 120 and the compressor 140.

In addition, in this embodiment, as illustrated in FIG. 1, the explanation was given of the case in which the discharge opening 142 is provided to carry out a puffing. However, the puffing step may be omitted because the lignin entanglements in most of the lignocellulosic biomass are already being released by the milling that is carried out using the screw 110 and the barrel 120, and polysaccharide components are being exposed. When no puffing is carried out, the discharge opening 142 can have a larger diameter. In addition, in such a case, there is no need to have the compressor 140.

Still further, in this embodiment, the explanation was given of the case in which the ratio between the groove depth D1 of the first screw groove 110a at the forefront end and the groove depth D2 of the second screw groove 110b at the backmost end is 70:100 (D1:D2=70:100) (FIG. 1). However, the ratio D1:D2 can be set as needed in consideration of the type of the material (lignocellulosic biomass).

Yet further, in this embodiment, the explanation was given of the case in which the ratio between the width W1 of the barrel groove 120a at the forefront end and the width W2 of the barrel groove 120a at the backmost end is 20:100 (W1:W2=20:100) (FIG. 1). However, the ratio W1:W2 can be set as needed in consideration of the type of the material (lignocellulosic biomass).

Next, an explanation will be given below of a lignocellulosic biomass treatment method, and a treated lignocellulosic biomass product according to the embodiment of the present disclosure.

The lignocellulosic biomass treatment method according to the embodiment of the present disclosure includes:

(i) a milling step of milling, by the rotating screw 110, the lignocellulosic biomass while applying pressure thereto in the gap 135 between at least one screw 110 that has spiral screw grooves 110a, 110b formed in the outer periphery thereof, and the barrel 120 that has the spiral barrel groove 120a formed in the inner periphery thereof, and surrounds a portion of the screw 110 where the screw grooves 110a, 110b are formed; and

(ii) a heating step of heating the milled lignocellulosic biomass by the heater 150 provided in the vicinity of the front end of the barrel 120.

Details on the lignocellulosic biomass applied in the milling step (i) are as described above. In addition, the screw 110, the barrel 120, and the gap 135 are also as described above.

Details on the heater 150 in the heating step (ii) are as described above. The heater 150 heats up the lignocellulosic biomass that has been milled in the gap 135 to 110-180° C. By heating the lignocellulosic biomass to 110-180° C., the entanglements of lignin are released, and polysaccharide components can be easily exposed.

The lignocellulosic biomass treatment method according to this embodiment of the present disclosure may further include a step of puffing the milled lignocellulosic biomass after the aforementioned heating step (ii). The puffing is carried out by gradually feeding, by the rotating screw 110, the milled lignocellulosic biomass to the compressor internal section 145 of the compressor 140 provided in the front end of the barrel 120, and by ejecting the lignocellulosic biomass that has been accumulated, pushed and pressurized under the substantially sealed condition in the compressor internal section 145 from the discharge opening 142 provided in the front surface 140a of the compressor 140. The puffing step accelerates the release of lignin entanglements in the lignocellulosic biomass. The suitable diameter of the discharge opening 142 is selected in consideration of the type of lignocellulosic biomass to be put.

Note that the lignocellulosic biomass may be milled after the puffing as described above. Example milling means applicable is milling that is carried out by a pin mill machine.

The treated lignocellulosic biomass product according to this embodiment of the present disclosure is obtained by the aforementioned treatment method. A water content of the treated lignocellulosic biomass product is, for example, between 10 and 50%. The aforementioned treatment method enables the release of lignin entanglements in the cellulosic biomass, and the exposure of polysaccharide components. Thus, the saccharification efficiency can be significantly improved when the treated lignocellulosic biomass product is used in the saccharification reaction. In addition, the treated lignocellulosic biomass product according to this embodiment of the present disclosure can be fermented when mixed with a hydrolase (for example, a hydrolase contained in rice malt), and yeast (for example, baker's yeast). In this case, the fermentation can be progressed at room temperature (for example, at 15-30° C.). Accordingly, by applying the treated lignocellulosic biomass product of this embodiment of the present disclosure, the fermentation can be efficiently progressed without a temperature control.

As described above, according to the lignocellulosic biomass treatment method of this embodiment of the present disclosure, the lignocellulosic biomass can be successively milled by the rotating screw 110, and thus the entanglements of lignin in the cellulosic biomass can be released, and polysaccharide components can be exposed in a short time (for example, substantially five to 30 seconds depending on rotational speed), and in an efficient manner. Therefore, the saccharification efficiency can be significantly improved when the treated lignocellulosic biomass product of this embodiment of the present disclosure is applied.

In addition, according to the lignocellulosic biomass treatment method of this embodiment of the present disclosure, no chemicals are applied, and no large-scale facilities are needed, and thus the lignocellulosic biomass can be treated at low costs.

Next, a lignocellulosic biomass saccharification method according to the embodiment of the present disclosure will be explained.

The lignocellulosic biomass saccharification method according to this embodiment of the present disclosure includes a step of saccharifying the aforementioned treated lignocellulosic biomass product.

In the saccharification, for example, a hydrolase is applied. Example hydrolase applicable are cellulase (for example, Novozymes 50013); β-glucosidase (for example, Novozymes 50010); amylase (for example, SIGMA, A7595); amyloglucosidase (for example, SIGMA, A7095); and hemicellulase. These hydrolases may be applied individually, or a combination of two or equal to or greater than three types of hydrolases may be applied. In addition, rice malt, baker's yeast, and the like may be used in the saccharification. Example saccharification method applicable is, mixing the treated lignocellulosic biomass product of this embodiment of the present disclosure, citrate buffer, cellulase, β-glucosidase, and water, and incubating the mixture at 50° C. for 72 hours. Any saccharification method that accomplishes the effects of the present disclosure is also applicable as needed.

The lignocellulosic biomass saccharification method of this embodiment of the present disclosure uses the treated lignocellulosic biomass product of this embodiment of the present disclosure that contains released lignin entanglements, and exposed polysaccharide components, thereby significantly improving the saccharification efficiency.

### EXAMPLES

### First Example

A saccharification test was conducted using corn dusts, broken corns, and corn stovers which were treated by the lignocellulosic biomass treatment device shown in FIG. 1.

First, each material was treated as follows.

Corn dusts (produced in the U.S.A., dent kind) (water content of substantially 25%), broken corns (produced in the U.S.A., dent kind), or corn stovers (Pioneer Hybrid Japan 39B29, produced in Shintoku-cho, Hokkaido) were treated for substantially ten seconds by the lignocellulosic biomass treatment device shown in FIG. 1, and thus the treated corn dust product, the treated broken corn product, or the treated corn stover product were obtained. Note that a temperature of the heater 150 was set in the range of 140 to 150° C.

### (Composition Analysis)

Composition analysis was conducted on the treated corn dust product, the treated broken corn product, and the treated corn stover product as obtained above.

The composition analysis was conducted in accordance with the analysis methods established by the National Renewable Energy Laboratory (NREL) in the United States of America.

Extractives: NREL/TP-510-42619 substances extracted with the aid of water and alcohol

Saccharides and lignin: NREL/TP-510-42618

Ash: NREL/TP-510-42622

Results of the composition analysis are shown below. Note that in the table, each numerical value of glucan is indicated as a total content of cellulose and starch. In addition, the unit of the numerical value in the table is “%”.

TABLE 1

| | Glucan | Xyran | Galactan | Arabinan | Lignin | Ash | Protein | Extractive |
|---|---|---|---|---|---|---|---|---|
| Corn dusts | 64.2 | 5.6 | 1.3 | 3.2 | 7.2 | 1.3 | — | 15.2 |
| Broken corns | 70.7 | 2.1 | 0.4 | 1.9 | 6.0 | 0.7 | — | 13.2 |
| Corn stovers | 45.0 | 20.9 | 0.0 | 2.6 | 19.4 | 1.9 | 1.3 | 14.3 |

### (Saccharification Test)

A saccharification test was conducted in accordance with NREU/TP-510-42629.

The treated corn dust product, the treated broken corn product, or the treated corn stover product as obtained above was added to each 30-mL container at an amount that was cellulose equivalent of 0.1 g. Subsequently, 5 mL of citrate buffer, cellulase (Novozymes 50013) 25 FPU/g-cellulose, β-glucosidase (Novozymes 50010) 42 CBU/g-cellulose, and an antibiotic were also added, and water was added to make a total of 10 mL. In addition, 30 mL containers each containing each treated product, citrate buffer, an antibiotic, and water with the same respective amounts as the above (but containing no cellulase, and β-glucosidase) were prepared as blanks. These containers were incubated at 50° C. for 72 hours. Glucose was measured by liquid chromatography, and a saccharification rate was calculated for each solution having undergone the incubation.

As a result of the saccharification test, the saccharification rate was 100% for the treated corn dust product, and the treated broken corn product, while the saccharification rate was 88.9% for the treated corn stover product. Conversely, each blank showed almost no elution of glucose.

In addition, cellulase (Novozymes 50013) was replaced with amylase (SIGMA, A7595), and amyloglucosidase (SIGMA, A7095) in the aforementioned saccharification test, and the saccharification test was likewise conducted for the treated com stover product. As for a result, the saccharification rate was 97% when amylase and amyloglucosidase were applied with reference to the saccharification rate in the aforementioned saccharification test using cellulase when defined as 100%.

Therefore, this example shows that the saccharification is carried out at higher efficiency when various types of treated lignocellulosic biomass products that are treated by the lignocellulosic biomass treatment device of the embodiment are applied in the saccharification reaction.

### Second Example

A fermentation test was conducted using corn dusts, broken corns, corn stovers, and woody chips which were treated by the lignocellulosic biomass treatment device shown in FIG. 1.

First, each material was treated as follows.

### (Treatment of Corn Dusts)

Corn dusts (produced in the U.S.A., dent kind) with a size of 0.1-6.0 mm were treated for ten seconds by the lignocellulosic biomass treatment device that is shown in FIG. 1. A temperature of the heater 150 was set at 160° C. Note that after the treatment for ten seconds, the temperature in the compressor 140 was maintained at 150-160° C. for a while even though a power switch of the heater 150 was turned off. The corn dusts having undergone the puffing and ejected from the discharge opening 142 had a water content of 15-30%. The corn dusts that had undergone the puffing, and ejected from the discharge opening 142 were cut into pieces with a length of 2 cm, and thereafter milled by a free milling machine (a pin mill) (Nara Machinery Co., Ltd.) and reduced in a particle diameter of equal to or less than 109 μm, and thus the treated corn dust product was obtained.

### (Treatment of Broken Corns)

The broken corns (produced in the U.S.A., dent kind) with a size of 0.1-10.0 mm were likewise treated as described above, and the treated broken corn product was obtained.

### (Treatment of Corn Stovers)

The corn stovers (produced in Shintoku-cho, Hokkaido) with a size of 1-15 mm was likewise treated as described above, and the treated corn stover product was obtained.

### (Treatment of Woody Chips)

The woody chips (a composite kind, produced in Japan, water content of 27%) with a length and a width of 1-5 mm, respectively, were likewise treated as described above, and the treated woody chip product was obtained. Note that after the treatment by the lignocellulosic biomass treatment device shown in FIG. 1, no milling was performed, and the substance that had undergone the puffing, and ejected from the discharge opening 142 was obtained as a treated woody chip product. The length and the width of the treated woody chip product were 0.1-3 mm, respectively.

### (Fermentation Test)

Four 1.5-L containers with respective lids were prepared. In each of the four containers, 50 g of the treated corn dust product, the treated broken corn product, the treated com stover product, or the treated woody chip product as obtained above, 1 g of baker's yeast (Lesaffre), 3 g of rice malt (Maruai Shimizu Jyozo Limited Partnership Company), and 250 mL of purified water (water temperature of 23° C.) were added, stirred, and sealed. The room temperature was maintained at 22° C.

Six hours later, in accordance with the generation of carbon dioxide caused by the fermentation, each of the four containers started expanding, and thus ventilation was performed. Thereafter, the ventilation was performed every five hours for six times, and carbon dioxide was released. At the time of the ventilation 36 hours later, the release of carbon dioxide had become very small.

Therefore, this example shows that by applying the various types of treated lignocellulosic biomass products that are treated by the lignocellulosic biomass treatment device of the embodiment, the saccharification is efficiently performed with a hydrolase that is contained in rice malt at room temperature within a short time, and subsequently the fermentation is progressed with baker's yeast.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present application claims the benefit of Japanese Patent Application No. 2013-267588 filed on Dec. 25, 2013. The entire contents of Japanese Patent Application No. 2013-267588 including specification, claims, and drawings are hereby incorporated by reference in this specification.

### REFERENCE SIGNS LIST

100 Lignocellulosic biomass treatment device
110 Screw
110a First screw groove
110b Second screw groove
110c Peak
110d Journal
111 First bottom surface
111a First side surface
111b Second side surface
111c Third side surface
112a First edge
112b Second edge
112c Third edge
115 Second bottom surface
115a Fourth side surface
115b Fifth side surface
115c Sixth side surface
116a Fourth edge
116b Fifth edge
116c Sixth edge
120 Barrel
120a Barrel groove
120b Peak
121 Cylindrical member
122 Flange
130 Chute
130a Chute inlet
135 Gap
140 Compressor
140a Front surface
142 Discharge opening
145 Compressor internal section
150 Heater
170 Bearing
170a Bearing surface
200 Lignocellulosic biomass treatment device
300 Lignocellulosic biomass treatment device

1. A lignocellulosic biomass treatment device comprising:
at least one screw that includes a screw groove in a spiral shape formed in an outer periphery of the screw;
a barrel that includes a barrel groove in a spiral shape formed in an inner periphery of the barrel, and surrounding a portion of the screw where the screw groove is formed; and
a chute to put a lignocellulosic biomass into a gap between the screw and the barrel,
wherein by a rotation of the screw, the lignocellulosic biomass is milled while a pressure is applied thereto in the gap.

2. The lignocellulosic biomass treatment device according to claim 1, further comprising a heater provided in a vicinity of a front end of the barrel and heating the milled lignocellulosic biomass.

3. The lignocellulosic biomass treatment device according to claim 1, further comprising a compressor that includes a discharge opening in the front end of the barrel.

4. The lignocellulosic biomass treatment device according to claim 1, wherein a depth of the screw groove becomes shallower toward a front side.

5. The lignocellulosic biomass treatment device according to claim 1, wherein a width of the barrel groove becomes narrower toward the front side.

6. The lignocellulosic biomass treatment device according to claim 1, wherein the screw groove includes a bottom surface, two side surfaces that stand upwardly from the bottom surface at a predetermined angle, and a side surface that stands upwardly from at least one of the two side surfaces at a predetermined angle.

7. The lignocellulosic biomass treatment device according to claim 1, wherein a groove pitch at a front end side in the screw groove is smaller than a groove pitch at a back end side.

8. The lignocellulosic biomass treatment device according to claim 1, wherein a number of the screws is two.

9. A lignocellulosic biomass treatment method comprising:
a milling step of milling, by a rotation of a screw, a lignocellulosic biomass while applying pressure thereto in a gap between at least the one screw that includes a screw groove in a spiral shape formed in an outer periphery of the screw, and a barrel that includes a barrel groove in a spiral shape formed in an inner periphery thereof, and surrounding a portion of the screw where the screw groove is formed; and
a heating step of heating the milled lignocellulosic biomass by a heater provided in a vicinity of a front end of the barrel.

10. The lignocellulosic biomass treatment method according to claim 9, further comprising a step of puffing the milled lignocellulosic biomass after the heating step.

11. A treated lignocellulosic biomass product obtained by the treatment method according to claim 9.

12. A lignocellulosic biomass saccharification method comprising a step of saccharifying the treated lignocellulosic biomass product according to claim 11.
